(19) United States
(12) Patent Application Publication
(10) Pub. No.: US 2009/0058609 A1
(43) Pub. Date: Mar. 5, 2009

(54) COUPON PROVIDED WITH RFID TAG AND METHOD OF USING THE SAME

(76) Inventor: Henry M. CLAYMAN, Miami, FL (US)

Correspondence Address: BERENATO, WHITE & STAVISH, LLC, 6550 ROCK SPRING DRIVE, SUITE 240, BETHESDA, MD, 20817, US

(21) Appl. No.: 12/203,438

(22) Filed: Sep. 3, 2008

Related U.S. Application Data
(60) Provisional application No. 60/935,895, filed on Sep. 5, 2007.

(51) Int. Cl. H04Q 5/22

(52) U.S. Cl. 340/10.1

(57) ABSTRACT

A coupon commercially associated with a product comprises a base sheet and an RFID tag secured to the base sheet The RFID tag stores coupon data including data identifying the product commercially associated with the coupon and a monetary amount of discount on the product. A method of purchasing the product comprises the steps of providing a customer with the coupon commercially associated with the product and a retail store including an RFID reader at a cashier station. The coupon comprises an RFID tag storing coupon data including data identifying the product commercially associated with the coupon and a monetary amount of discount on the product. The method further includes the steps of reading a product data and the coupon data at the cashier station, and reducing the retail price of the product when the coupon data matches the product data.

This application is a U.S. Utility Patent Application based on U.S. Provisional Patent Application No. 60/935,895 filed Sep. 5, 2007, and is hereby incorporated by reference in its entirety.

### BACKGROUND OF THE INVENTION

1. Field of the Invention

The present invention relates to discount, promotional and cross-merchandizing coupons in general, and more particularly to such coupons provided with Radio Frequency Identification (RFID) tags.

2. Description of the Prior Art

Various technologies have been developed for identifying and tracking objects. The most common involves application of identifying bar codes to objects and optically scanning those codes to identify the objects or certain other relevant coded characteristics, e.g., size, model, price, etc. A more recent development is radio frequency identification technology, commonly known as RFID technology. RFID devices, commonly called RFID tags, are thin transponders (transceivers) that include an integrated circuit chip having RF (radio frequency) circuits, control logic and memory, plus an antenna, all mounted on a supporting substrate. RFID devices are either of the active type or passive type. The active type RFID tags include a battery for powering a transceiver. The passive type RFID tags have no battery and derive its energy from the RF signal used to interrogate it. The RFID transponder operates to receive, store and transmit object-identifying data to and from the memory within the chip. The device functions in response to coded RF signals received from a base station. Typically it reflects the incident RF carrier back to the base station, and information stored in the device is transmitted back to the interrogating base station by modulating the reflected signal according to the programmed information protocol.

Recent developments have produced thin RFID tags on flexible organic substrates, with the overall thickness of the tags being of the order of a fraction of a millimeter, typically about 1.5 mils thick. Various materials have been used as the organic substrate of commercial RFID tags, including but not limited to thin flexible films of a polyester such as Mylar®™ or a polyimide such as Kapton®™. The antenna may comprise pre-formed wires that are attached to the substrate, but more commonly it is a thin film element, usually consisting of 25 to 25 micron thick copper lines formed by plating copper onto the flexible organic substrate or by etching in the case where the substrate is a copper/organic material laminate. Further information regarding the manufacture and use of RFID transponders is provided by U.S. Pat. No. 5,497,140, issued Mar. 5, 1996 to J. R. Tuttle; U.S. Pat. No. 5,528,222, issued Jun. 18, 1996 to P. A. Moskowitz et al.; U.S. Pat. No. 5,566,441, issued Oct. 22, 1996 to M. J. C. Marsh et al.; U.S. Pat. No. 5,661,473, issued Aug. 26, 1997 to J. P. Paschal; U.S. Pat. No. 5,682,143, issued Oct. 28, 1997 to M. J. Brady et al.; U.S. Pat. No. 5,995,951, issued Sep. 21, 1999, and U.S. Pat. No. 6,018,299, issued Jan. 25, 2000 to N. H. Eberhardt, The greatest disadvantage of bar codes is that they are not dynamic carriers of information, require direct or proximal line of sight contact for reading and are adversely impacted by dirt, grime and soiling. With bar codes the stored information is static. Consequently information stored in bar codes on an object cannot be updated as it travels, for example, from a shipper to a receiver. In contrast, RFID tags are programmable and offer the capability of updating recorded information at any time and in real time. The information stored in the RFID tag may be updated using a writing device to wirelessly transmit the new information to be stored. Updating information in bar code tags typically requires printing a new tag to replace the old. RFID transponders are of particular value to industries that need to quickly and accurately track and manage very large numbers of objects. The passive type of RFID tag is particularly valuable in relation to inventory management and control because it offers a long life data storage and retrieval capability, since it draws its energy and transfers information in the form of low power radio waves resulting from operation of the read/write module of a base station.

Small lightweight RFID foil tags have long been implemented in security systems in retail stores. The foil RFID tag is secured to a product and is capable of storing information regarding the product or sale status. A RFID interrogator is used to read the tag, record the sale of the item, and write to the tag to change the status to purchased, to allow the product and tag to leave the store without tripping the stores security alert system. The technology to use such RFID tags for inventory and assembly lines etc. are known in the art to facilitate reading and writing to small RFID foil tags without contact and without the need for a power supply to the tag itself. Rather, the tag relies on modulated radio frequencies from the RFID reader/writer to exchange information. Various RFID systems are disclosed in U.S. Pat. Nos. 6,717,507; 6,806,808; 5,055,659; 5,030,807; 6,107,910; 6,580,358; and 6,778,847 each of which are hereby incorporated herein by reference.

RFID tags are rapidly becoming the preferred method of inventory tracking in retail and distribution applications and will likely surpass bar codes as the preferred point-of-sale checkout identifier. For example, bar codes are limited in size by resolution limitations of bar code scanners, and the amount of information that the symbols can contain is limited by the physical space constraints of the label. Therefore, some objects (products or merchandise) may be unable to accommodate bar code labels because of their size and physical configuration. In contrast, RFID tags store their information in digital memory. Thus, they can be made much smaller than bar code tags.

With this in mind, a need exists to develop a coupon associated with a piece of merchandise that includes an RFID tag for improving and facilitating the use of a merchandising/promotional coupon by a customer and to gain insight into purchaser's buying habits, preferences and check-out functions, e.g. which debit/credit card is used if payment is by cash or check.

### SUMMARY OF THE INVENTION

The present invention is directed to a novel coupon commercially associated with a product and provided with a radio frequency identification (RFID) tag and a method of using the same.

According to one aspect of the invention, a coupon commercially associated with a product is provided. The coupon comprises a base sheet provided with printed material on at least one of sides thereof, and a radio frequency identification tag secured to the base sheet. The radio frequency identification tag stores coupon data including data identifying the product commercially associated with the coupon and a monetary amount of discount on the product. Furthermore, the coupon data stored in the coupon according to the present invention may further include additional information other than the data identifying the product and the monetary amount of discount.

According to another aspect of the invention, there is a method of purchasing a product. The method of the present invention comprises the following steps. First, a customer is provided with a coupon commercially associated with the product. The coupon comprises a radio frequency identification tag storing coupon data including data identifying the product commercially associated with the coupon and a monetary amount of discount on the product. Next in a retail store where an RFID reader at a cashier station is provided, the product data of the product to be purchased including the retail price thereof is read at the cashier station. The subsequent coupon data including the data identifying the product associated with the coupon and the monetary amount of discount on said product is compared with the product data of the product to be purchased, the coupon data having been read at the cashier station When the coupon data matches the product data of the product, the retail price of the product is reduced by the amount of discount of the product as stored in the coupon, at the cashier station. Furthermore, the coupon data stored in the coupon according to the present invention may further include additional information other than the data identifying the product and the monetary amount of discount. The additional information from the coupon may be obtained in the store with a stand-alone RFID reader at a location remote from the cashier station, or at a customer's home with a personal (home) RFID reader.

Therefore, the present invention provides a novel coupon with a RFID tag and a method of using the same for marketing, promoting and merchandising retail products, as well as for the conventional use of the RFID tag, such as tracking, inventory control and check-out.

### BRIEF DESCRIPTION OF THE DRAWINGS

Other objects and advantages of the present invention will become apparent from a study of the following specification when viewed in light of the accompanying drawings, wherein:

FIG. 1A is a perspective view of an exemplary discount coupon provided with an RFID tag according to the present invention;

FIG. 1B is a perspective view of an exemplary cross-merchandizing coupon provided with an RFID tag according to the present invention;

FIG. 2 is a schematic view of an RFID tag suitable for use with the present invention;

FIG. 3A is a perspective view of a retail product provided with the sample discount coupon according to the present invention attached to the retail product;

FIG. 3B is a perspective view of a retail product provided with the exemplary discount coupon according to the present invention loose within a box of the retail product;

FIG. 3C is a perspective view of a retail product provided with the exemplary cross-merchandizing coupon according to the present invention hanging from the retail product;

FIG. 3D is a perspective view of an exemplary free-standing give-away discount coupon according to the present invention;

FIG. 4 is a schematic view of a system using the discount coupon according to the present invention at a retail store;

FIG. 5 is a schematic view of a system using the discount coupon according to the present invention at home.

### DETAILED DESCRIPTION OF PREFERRED EMBODIMENTS

The preferred embodiment of the present invention will now be described with the 10 reference to accompanying drawings.

For purposes of the following description, certain terminology is used in the following description for convenience only and is not limiting. The words “right,” “left,” “down”, “up”, “top” and “bottom” designate directions in the drawings to which reference is made. The terminology includes the words above specifically mentioned, derivatives thereof and words of similar import. Additionally, the word “a”, as used in the claims, means “at least one.”

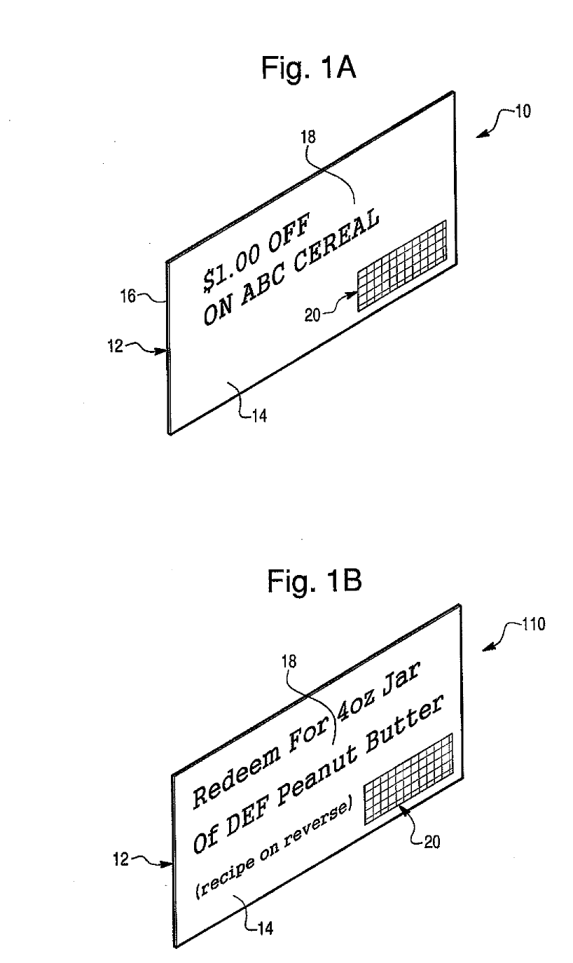

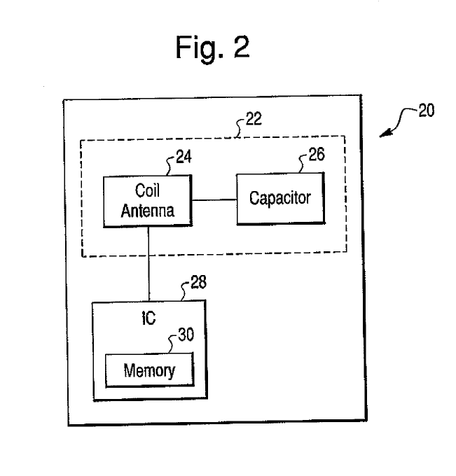

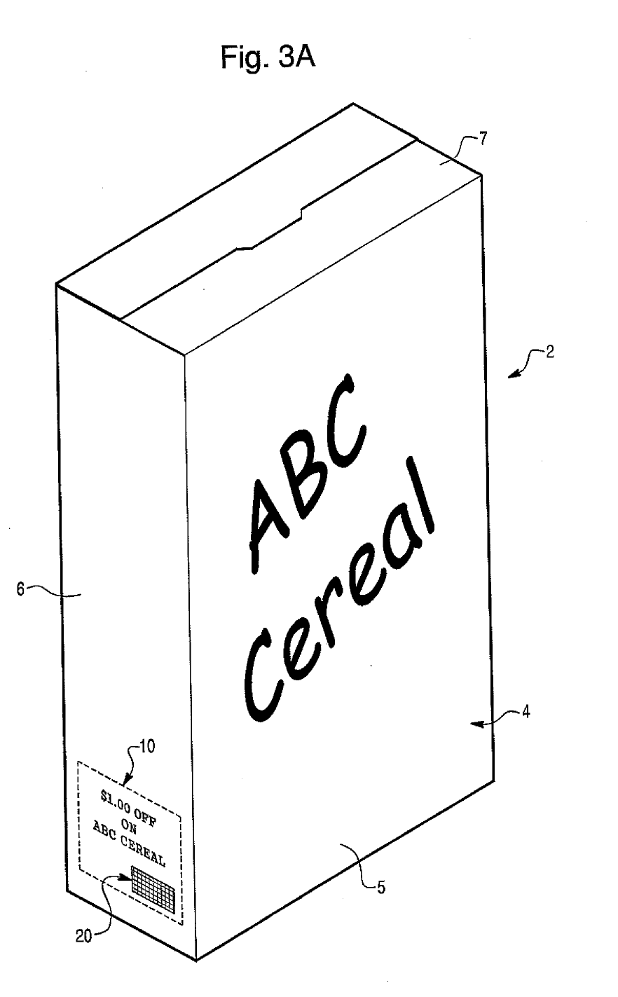

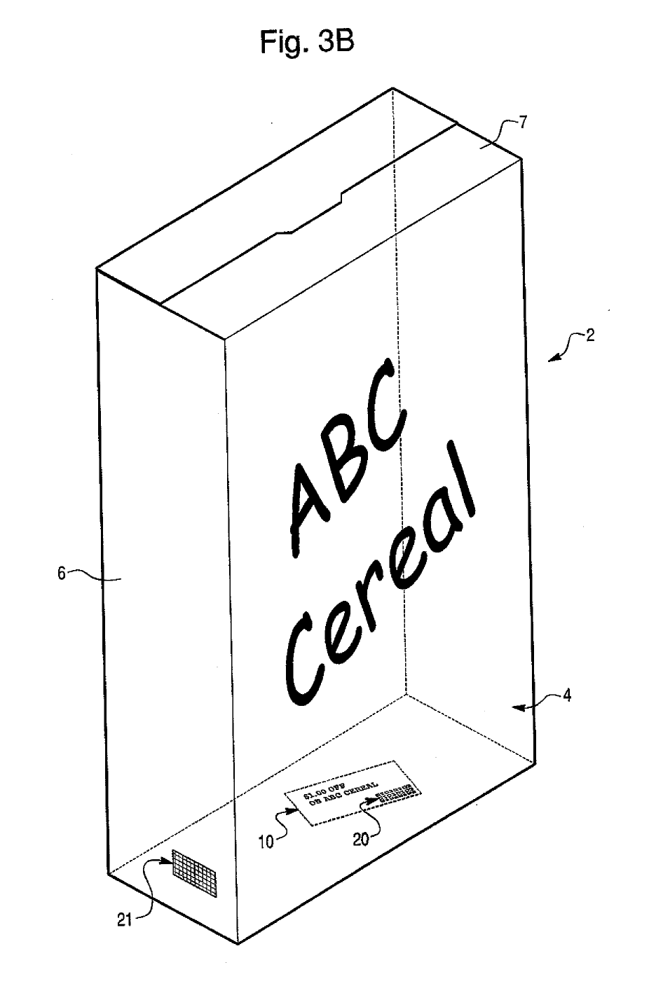

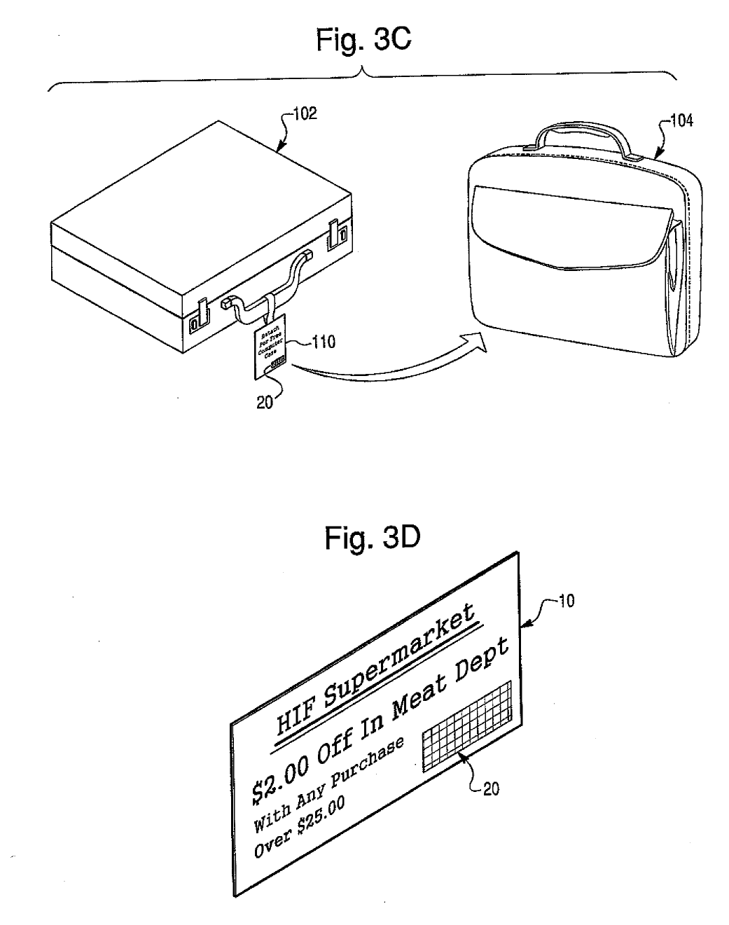

FIG. 1A of the drawings illustrates an exemplary discount coupon in accordance with the teachings of the present invention generally depicted by reference numeral 10. The discount coupon 10 is commercially associated with a piece of merchandise (also referred hereinbelow as a product) depicted by reference numeral 2 as illustrated in FIGS. 3A and 3B. The piece of merchandise associated with the coupon 10 may be a retail product (i.e. a piece of merchandise sold in a retail store) or a wholesale product (i.e. a piece of merchandise stockpiled in a warehouse). Moreover, the piece of merchandise (or the product) associated with the coupon 10 may be a food item, such as agricultural products (e.g. fruit, vegetable, meet, milk, eggs, etc.), cereal, pasta, sausage, etc., or an article of manufacturing, such as a bag, briefcase, book, electronic equipment, etc.

The discount coupon 10 according to the present invention comprises a base sheet (or substrate) 12 having a front face 14 and a rear face 16 opposite to the front face 14. The front face 14 is provided with printed material 18. Preferably, the printed material 18 includes wording, such as “$1.00 OFF ON ABC CEREAL”, as shown in FIG. 1A. Alternatively, the rear face 16 may also be provided with some sort of printed material. Furthermore, the discount coupon 10 includes a radio frequency identification (RFID) tag 20 that stores coupon data, i.e. various data related to an article or retail product 2 (shown in FIG. 3) commercially associated with the discount coupon, including data identifying the product 2 commercially associated with the coupon 10 and a monetary amount of discount on the retail product 2 commercially associated with the discount coupon 10. It should be understood that the coupon is considered to be commercially associated with a particular product if the coupon data (i.e., data identifying a product, a monetary amount of discount on the product and any additional information) is related to this particular product regardless of being physically associated with (i.e. attached to or enclosed in) this particular product or not. The RFID tag 20 of the present invention may be both active and passive type. The RFID tag 20 is attached or printed on one of the front or rear faces 14 or 16, respectively, of the base sheet 12 of the discount coupon 10 of the present invention.

FIGS. 1B and 3C illustrate an exemplary cross-merchandizing coupon 110 with the RFID tag 20. The cross-merchandizing coupon 110 is physically attached to the product 102 (shown in FIG. 3C), however is associated with (i.e. provides a discount on) different merchandise 104, not the product 102 it is provided with. In other words, the cross-merchandizing coupon 110 markets and promotes the sale of merchandise 102 physically attached to the coupon 110, and introduces merchandise 104 which is not physically provided with the cross-merchandising coupon 110, to the consumer as a retail product of the same or different manufacturer as the merchandise 102 physically associated with the cross-merchandizing coupon 110. Here again, the front face 14 is provided with printed textual material 18. Preferably, the printed textual material 18 includes wording, such as “$1.00 OFF ON ABC CEREAL” (as shown in FIG. 1A) or “DETACH FOR FREE COMPUTER CASE” (as shown in FIG. 3C). Alternatively, the rear face 16 may also be provided with some sort of printed material, such as a recipe including the product associated with the cross-merchandizing coupon l 10 as an ingredient, if the product is a food product, or an advertisement for computer accessories in the example of FIG. 3C.

FIG. 2 schematically illustrates the exemplary embodiment of the RFID tag 20 suitable for use with the discount coupon of the present invention. The RFID tag 20 comprises a passive resonant radio frequency (RF) circuit 22 for use in detecting when the RFID tag 20 is within a zone monitored by a reader or interrogator, as is well-known in the art. One well-known type of circuit 22 has a coil antenna 24 and a capacitor 26 which together form a resonant circuit with a predetermined resonant frequency, i.e. the selected radio frequency determined by the values of the coil and the capacitor. Power for the RFID tag 20 is derived from an incident signal to the antenna 24 in a conventional manner. Furthermore, the RFID tag 20 includes an integrated circuit (IC) 28 for providing “intelligence” to the RFID tag 20.

The IC 28 is electrically connected to the resonant circuit 22. The capacitor 26 may be either external to the IC 28, or the capacitor 26 may be within the IC 28, depending upon the desired implementation of the circuit 22. The IC 28 includes a programmable memory 30, such as a 20 bit memory, for storing the coupon data including bits of the product identification data and the monetary amount of discount on the product associated with the discount coupon 10 (or 110). The IC 28 outputs a data stream comprised of the stored data (i.e. 20 bits in the present embodiment) when sufficient power from the antenna 24 is applied thereto. In one embodiment of the invention, the data stream creates a series of data pulses by switching an extra capacitor (not shown) across the coil antenna 24 for the duration of the data pulses. The addition of the extra capacitor changes the resonant frequency of the RF circuit 22, detuning it from the operational frequency. Thus, instead of the RF circuit 22 returning a simple single frequency response signal, it returns a signal containing a packet of preprogrammed information. The packet of information (data pulses) is received and processed by interrogator receiving circuitry and is decoded (if necessary) to provide identification information about the retail product 2 associated with the RFID tag 20, i.e. the retail product 2 to which the discount coupon 10 is secured or attached. Other methods of using the data in the memory 30 to output identification data from the RFID tag 20 are within the scope of the invention. The IC 28 is preferably also a passive device and is powered in the same manner as the RF circuit 22 (i.e., by using energy received at the antenna 24 from the interrogator transmitter signal). It will be appreciated that any type of RFID tags is within the scope of the present invention. Examples of other RFID tags which are suitable for use as the RFID tag 20 of the present invention are shown in U.S. Pat. No. 5,446,447 (Carney et al.), U.S. Pat. No. 5,430,441 (Bickley et al.), and U.S. Pat. No. 5,347,263 (Carroll et al.). Typically, RFID tags are not subject to physical deactivation. In other words, no physical change or change of magnetic state occurs to the state of the coil capacitor or any other element comprising the antenna circuit of such RFID tags. An RFID tag which may not be physically deactivated has significant advantages over physically deactivatable magnetic security tags and/or prior art physically deactivatable RF security tags which are commonly used today because such RFID tags are more difficult to bypass. Preferably, the RFID tag 20 is non-physically deactivatable RFID tag. Alternatively, a physically deactivatable RFID tag may be used. Although the preferred embodiment of the RFID tag 20, illustrated in FIG. 2, includes a resonant circuit having a coil antenna and a capacitor and an IC, an RFID tag which has only a coil antenna and an IC is also within the scope of the present invention. Preferably, the RFID tag 20 is re-usable; however disposable RFID tags are also within the scope of the present invention.

In the exemplary embodiment illustrated in FIGS. 3A and 3B, the retail product 2 is a box of cereal and includes a box 4 filled with cereal or corn flakes. The box 4 has opposite front and rear walls 5, opposite side walls 6, and opposite top and bottom walls 7. The discount coupon 10 of the present invention may be secured to any one of the walls 5, 6 or 7 of the box 4. In the exemplary embodiment of FIG. 3A, the discount coupon 10 is attached to one of the side walls 6. Alternatively, the discount coupon 10 may be separate from the box 4 and located loose inside thereof (i.e. within the box 4 of the retail product 2), as illustrated in FIG. 3B. It will be appreciated that the loose coupon 10 within the box 4 can be scanned through the box (container) 4 so the discount can be taken at a point of sale, if the customer wishes, rather than at a later date after the customer has opened the box 4 and retrieved the coupon 10. Further alternatively, the RFID tag 20 may be attached or printed directly on one of the walls of the box 4.

In the exemplary embodiment illustrated in FIG. 3C, the exemplary cross-merchandizing coupon 110 with the RFID tag 20 is hung (removably attached) to a retail product 102 as a promotional coupon to provide a discount on the different merchandise 104, not the product 102 physically associated with the cross-merchandizing coupon 110. The exemplary embodiment of FIG. 3C the retail product 102 in the form of a briefcase provided with the cross-merchandizing coupon 10 attached to the handle of the briefcase 102 offering a free (or a 100% discount) computer case 104 (i.e. a different product of the same or different manufacturer) with the purchase of the briefcase 102.

In the exemplary embodiment illustrated in FIG. 3D, the discount coupon 10 is in the form of a free-standing, give-away, promotional coupon which may be handed out by a store employee or others as part of the store's marketing plan, i.e. in this case to popularize the meat department. The free-standing, give-away discount coupon 10 of FIG. 3D is not physically associated with any particular merchandise but is associated with any one product of a specific group of products. As an example, the free-standing, give-away discount coupon 10 of the exemplary embodiment illustrated in FIG. 3D, offers $2.00 off in meat department of the HIF Supermarket with any purchase over $25.00.

The information (data pulses) stored in the programmable memory 30 of the RFID tag 20 provides various data related to the product 2 (or 104) with which the discount coupon 10 is associated (or related). According to the present invention, the RFID tag 20 stores data identifying the retail product related to or associated with the discount coupon 10 (or 110), a monetary amount of discount on the retail product 2 (or 104) and additional data other than the product identifying data and the discount amount. The data identifying the retail product usually includes a product name, a brand name (manufacturer ID), and a product identification number. Preferably, the data identifying the retail product 2 (or 104) is a common Electronic Product Code (EPC). The EPC is known in the art as a family of coding schemes created as an eventual successor to the bar code. The EPC was created as a low-cost method of tracking goods using RFID technology. It is designed to meet the needs of various industries, while guaranteeing uniqueness for all EPC-compliant tags. EPC tags were designed to identify each item manufactured, as opposed to just the manufacturer and class of products, as bar codes do today. The EPC accommodates existing coding schemes and defines new schemes where necessary. All EPC numbers contain a header identifying the encoding scheme that has been used. This in turn dictates the length, type and structure of the EPC. EPC encoding schemes frequently contain a serial number which can be used to uniquely identify one object. EPC Version 1.3 supports the following coding schemes:
General Identifier (GID);
a serialized version of the GS1 Global Trade Item Number (GTIN);
GS1 Serial Shipping Container Code (SSCC);
GS1 Global Location Number (GLN);
GS1 Global Returnable Asset Identifier (GRAI);
GS1 Global Individual Asset Identifier (GIAI); and
DOD Construct.

The amount of discount includes a monetary amount of discount from a regular retail price of the product 2 (or 104). The monetary discount can be taken at checkout, or the customer can redeem the coupon 10 (or 110) at a subsequent shopping trip. With the latter customer information can thus be obtained on frequency, time, day, payment method and location of purchases, for example. Preferably, the additional data stored in the RFID tag 20 is information related to utilization of the piece of merchandise or consumer characteristics and parameters of the product (also referred hereinbelow as consumer information). The information related to utilization of the retail product 2 may include a number of various pieces of information useful to a consumer of the product 2 (or 104), such as recipe(s) that include the product 2 as an ingredient (if the product is a food item), information on how to store (storage instructions) (for both food items and articles of manufacturing) or use (usage instructions) the product 2, etc. As a further example, in case the product is a food item (such as agricultural product: produce (fruits, vegetables), meat, milk, eggs, etc.), the information related to utilization of the retail product 2 may include one or more recipes that include the product 2 as an ingredient. More specifically, the additional data stored in the RFID tag 20 may include a selected recipe name(s), a list and amount of ingredients, nutritional information relating to the recipe(s), etc. The information related to consumer parameters of the product may include nutritional value of the product 2 (if the product is a food item), technical characteristics and other information on the product 104 that might be useful for a consumer (if the product is an article of manufacturing), etc.

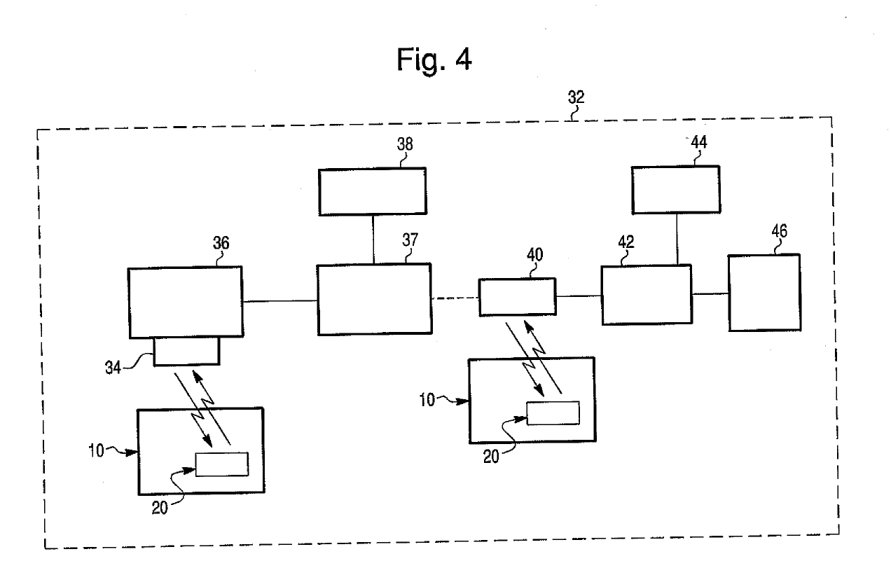

In a retail store 32, as illustrated in FIG. 4, the data identifying the retail product 2 related to the discount coupon 10, the monetary amount of discount on the retail product 2 is read by a RFID reader 34 at a cashier station 36 (point-of-sale checkout). The cashier station 36 is electronically connected to a retail store database 38 through a host computer 37 by wire or wirelessly. In operation, the data identifying the retail product to be purchased and a retail price thereof is read at the cashier station 36. Then, the discount coupon 10 is scanned so that the coupon data is read by the RFID reader 34 at the cashier station 36, transmitted through the host computer 37 to the retail store database 38 and electronically matched with the identifying data of the retail product 2 to be purchased. If they match, the discount coupon 10 is redeemed, and the retail price of the retail product 2 is reduced by the amount of discount on the retail product 2. Preferably, the retail product 2 is also provided with an RFID tag 21 (shown in FIG. 3B as attached to the box 4 of the retail product 2) storing a product data of the retail product 2 (i.e. a product identifying data, such as a common Electronic Product Code (EPC) stored by the RFID tag 21), which can be read by the RFID reader 34 at the cashier station 36 and transmit the obtained product identifying data to the retail store database 38.

The retail store 32 may further include at least one stand-alone RFID reader 40 located in any convenient location within the store 32. The stand-alone RFID reader 40 is connected to the retail store database 38. The RFID readers are conventionally known in the art and hence, the detailed description thereof is omitted. A customer can scan the RFID tag 20 of the coupon 10 with the stand-alone RFID reader 40 to retrieve the consumer information related to the retail product 2 stored in the RFID tag 20 (i.e., characteristics of the product, information related to utilization of the product, etc.). This information, such as the recipe that includes the product 2 associated with the coupon 10 as an ingredient, can be read by the stand-alone RFID reader 40 and sent to an electronic processor 42 electronically connected to the stand-alone RFID reader 40, to be displayed on a display 44 or printed on a printer 46.

Similarly, a warehouse which stores the pieces of merchandise may be provided with an RFID reader electronically connected to a warehouse database. Employees of the warehouse can check the information (data) stored in the radio frequency identification tag of the coupon associated with any particular piece of merchandise and update or modify this information if necessary using a conventional wireless writing device.

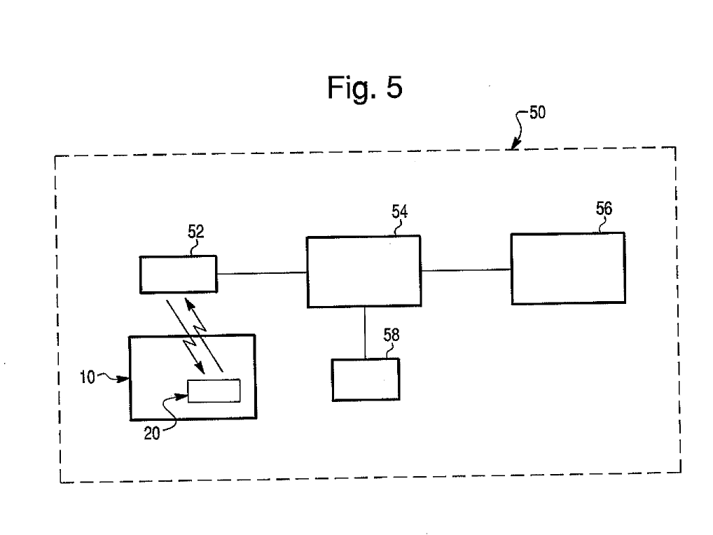

Furthermore, the discount coupon 10 (or 110) of the present invention can be used outside the retail store 32, such as at a customer's home 50 if the home 50 is equipped with a personal (or home) RFID reader 52 (shown in FIG. 5). More specifically, the customer can scan the RFID tag 20 of the coupon 10 with the home RFID reader 52 (after or before purchasing the product associated with the coupon 10 (or 110)) to retrieve the consumer information related to of the retail product 2 (or 104) stored in the RFID tag 20. As illustrated in FIG. 5, this information, such as the recipe that include the product 2 (or 104) as an ingredient or storage instructions or information related to utilization of the retail product 2 (or 104), can be read by the RFID reader 52 and sent to an electronic processor 54 electronically connected to the RFID reader 52, to be displayed on a personal display 56 or printed on a personal printer 58. This allows the customer to determine if the retail product 2 associated with the discount coupon 10 corresponds to the customer's needs (if the coupon is scanned before purchasing the product) or get information related to utilization of the retail product 2 (if the coupon is scanned after purchasing the product).

As the memory 30 of the RFID tag 20 is programmable, the information stored in the RFID tag 20 may be updated or modified using a writing device to wirelessly transmit the new information to be stored. The writing devices for wirelessly updating the information data stored in the memory of the RFID tags are known in the art and hence, the detailed description thereof is omitted. By contrast, updating information in bar code tags typically requires printing a new tag to replace the old. The specific amount of data can be added to the memory 30 of the RFID tag 20 at a factory manufacturing the product, or at the retail store selling this product or a warehouse storing the product.

Therefore, the present invention provides the manufacturer and/or merchant with a cost effective advantage of using a coupon with a single RFID tag for marketing, promoting and merchandising retail products, as well as for the conventional use of the RFID tag, such as tracking, inventory control and check-out.

The foregoing description of the preferred embodiments of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. It is also intended that the scope of the present invention be defined by the claims appended thereto.

What is claimed is:

1. A coupon commercially associated with a product, said coupon comprising:
a base sheet provided with printed material on at least one of sides thereof; and
a radio frequency identification tag secured to said base sheet;
said radio frequency identification tag storing coupon data including data identifying said product commercially associated with said coupon and a monetary amount of discount on said product.

2. The coupon as defined in claim 1, wherein said coupon data further includes additional information other than said data identifying said product and said monetary amount of discount.

3. The coupon as defined in claim 1, wherein said additional information is consumer information related to said product.

4. The coupon as defined in claim 3, wherein said additional information is information related to utilization of said product.

5. The coupon as defined in claim 4, wherein said product is a food item; and wherein said information related to utilization of said product includes at least one recipe that include said product as an ingredient.

6. The coupon as defined in claim 5, wherein said at least one recipe includes a recipe name, a list and amount of ingredients, nutritional information related to said at least one recipe.

7. The coupon as defined in claim 3, wherein said consumer information includes storage instructions for said product.

8. The coupon as defined in claim 4, wherein said information related to utilization of said product includes usage instructions for said product.

9. The coupon as defined in claim 3, wherein said additional information is information related to consumer parameters of said product.

10. The coupon as defined in claim 9, wherein said piece of merchandise is a food item; and wherein said information related to consumer parameters of said product includes nutritional value of said product.

11. The coupon as defined in claim 9, wherein said product is an article of manufacturing; and wherein said information related to consumer parameters of said product includes technical characteristics of said product.

12. The coupon as defined in claim 1, wherein said radio frequency identification tag comprises a resonant radio frequency circuit 22 and an integrated circuit 28 electrically connected to said resonant circuit 22.

13. The coupon as defined in claim 12, wherein said resonant radio frequency circuit includes a coil antenna and a capacitor which together form a resonant circuit with a predetermined resonant frequency.

14. The coupon as defined in claim 12, wherein said integrated circuit includes a memory for storing said data identifying said product commercially associated with said coupon and said monetary amount of discount.

15. The coupon as defined in claim 14, wherein said memory of said radio frequency identification tag is programmable so that said product identifying data and said monetary amount of discount stored in said radio frequency identification tag may be updated.

16. A method of purchasing a product, comprising the steps of:
a) providing a customer with a coupon commercially associated with said product, said coupon comprising a radio frequency identification tag storing coupon data including data identifying said product commercially associated with said coupon and a monetary amount of discount on said product;
b) providing a retail store including an RFID reader at a cashier station;
c) reading a product data of said product to be purchased including a retail price thereof at said cashier station;
d) reading said coupon data including said data identifying said product associated with said coupon and said monetary amount of discount on said product at said cashier station;
c) matching said product data of said product to be purchased and said coupon data; and
d) reducing said retail price of said product when said coupon data matches said product data of said product by said amount of discount on said product as stored in said coupon.

17. The method of purchasing said product as defined in claim 16, wherein said coupon data further includes additional information other than said data identifying said product and said monetary amount of discount.

18. The method of purchasing said product as defined in claim 17, further comprising the steps of:
providing said retail store with a stand-alone RFID reader at a location remote from said cashier station; and
obtaining said additional information with said stand-alone RFID reader.

19. The method of purchasing said product as defined in claim 18, wherein said stand-alone RFID reader is electrically connected to at least one of a display and a printer.

20. The method of purchasing said product as defined in claim 17, further comprising the steps of:
providing a customer's home including a personal RFID reader; and
obtaining said additional information with said personal RFID reader.

21. The method of purchasing said product as defined in claim 20, wherein said personal RFID reader is electrically connected to at least one of a personal display and a personal printer.
